(19) United States
(12) Patent Application Publication
(10) Pub. No.: US 2002/0074738 A1
(43) Pub. Date: Jun. 20, 2002

(54) Head gasket and fire ring assembly for optimizing a load distribution

(76) Inventors: Nathan R. Bjerk, Chillicothe, IL (US); Bradley J. Fink, Peoria, IL (US)

Correspondence Address: McGuire Woods LLP, ATTN: Andrew M. Calderon, Suite 1800, 1750 Tysons Boulevard, McLean, VA, 22102-4215, US

(21) Appl. No.: 09/740,498

(22) Filed: Dec. 19, 2000

(51) Int. Cl. F02F 11/00

(52) U.S. Cl. 277/601

(57) ABSTRACT

A head gasket assembly used in an internal combustion engine. The head gasket assembly optimizes a load distribution of the head gasket over an engine block of the internal combustion engine by decreasing a thickness profile of the head gasket assembly about a combustion chamber of the internal combustion engine. This increases the seal capabilities of the gasket assembly. The gasket assembly has a gasket body with an opening and tabs extending from the gasket body toward the opening. Cut-out portions are positioned between the tabs and a fire ring is provided about the opening. A wrap secures the fire ring to the tabs.

### TECHNICAL FIELD

This invention relates generally to a head gasket and more particularly to a head gasket assembly which optimizes a load distribution of the head gasket over an engine block.

### BACKGROUND ART

A conventional head gasket used in an internal combustion engine includes a body having openings which correspond to fluid passages and combustion chambers of an engine block. These conventional head gaskets also include combustion rings (otherwise known as a fire rings) which surround the openings corresponding with the respective combustion chambers of the internal combustion engine. The body of the head gasket seals the fluids such as, for example, coolant and lubricants, between the engine block and a head of the internal combustion engine. The fire rings, on the other hand, protect the body of the gasket from high temperatures and pressures by containing high pressure combustion gases within the combustion chamber of the internal combustion engine.

The fire ring is secured to the body of the head gasket via a wrap or flange. The wrap wraps around the entire outside circumference of the fire ring and extends over (e.g., overlaps) the opposing surfaces of the gasket body adjacent the entire fire ring. This ensures that the fire ring and the head gasket remain as a single assembly, and that the gasket body is adequately protected from the combustion chamber environment. The wrap, however, increases the thickness profile of the gasket body adjacent the combustion chambers due to the wrap overlapping the opposing surfaces of the gasket body.

During assembly of the internal combustion engine, the technician aligns the head gasket assembly on the engine block, including aligning the respective gasket openings with the combustion chambers. The head is then aligned with the engine block and thereafter bolted to the engine block. The head gasket assembly is then sandwiched between the engine block and head. In this manner, the head gasket ensures that fluids will be contained within the engine block and head assembly.

It is noted, however, that the increase in thickness of the gasket body due to the placement of the wrap causes an unequal load distribution on the entire gasket assembly. That is, more load is distributed about the circumference of the combustion chamber (and liner of the combustion chamber) than the remaining portions of the gasket body). This irregular load distribution, in turn, affects the load which may have otherwise been placed on other portions of the gasket assembly so as to better seal the fluids between the engine block and the head.

In accordance with a conventional system, U.S. Pat. No. 4,400,000 to Moerck, Jr. (Aug. 23, 1983) shows a head gasket assembly for diesel engines. Referring to FIGS. 1 and 2 of the Moerck, Jr. reference, it is seen that a fire ring is provided about a circumference of an opening in the gasket body which corresponds to a combustion chamber. The fire ring is secured to the gasket body by a wrap which, as best seen in FIG. 2 and FIG. 3, overlaps the entire edges of the gasket body adjacent the fire ring. As shown in FIG. 2, when the head and the engine block are bolted to one another, the wrap is provided with a load which is different than the remaining portions of the gasket body.

The present invention is directed to overcoming one or more of the problems as set forth above.

### DISCLOSURE OF THE INVENTION

In one aspect of the present invention, a gasket assembly has a gasket body with an opening formed therein. Tabs extend from the gasket body toward the opening and cut-out portions are positioned between the tabs. A fire ring is provided about the opening and a wrap secures the fire ring to the tabs.

In another aspect of the present invention, a gasket assembly has a gasket body with an opening and at least two tabs. At least two cut-out portions separate the tabs. A fire ring is positioned about the opening and a wrap wraps around the fire ring and extends to the tabs.

In another aspect of the present invention, an internal combustion engine having a gasket assembly is provided. The internal combustion engine has an engine block and a head mounted on the engine block. The gasket assembly is sandwiched between the engine block and the head. The gasket assembly has a gasket body and an opening formed therein. Tabs extend from the gasket body towards the opening and cut-out portions separate the tabs. A fire ring is positioned about the opening and a wrap secures the fire ring to the tabs.

### BRIEF DESCRIPTION OF THE DRAWINGS

FIG. 1 shows a diagrammatic top plan view of a gasket assembly of the present invention;

FIG. 2 shows a diagrammatic sectional view of the gasket assembly along lines 2-2 of FIG. 1;

FIG. 3 shows a sectional view of the gasket assembly along lines 3-3 of FIG. 1; and

FIG. 4 shows a side sectional view of an internal combustion engine using the gasket assembly of the present invention.

### BEST MODE FOR CARRYING OUT THE INVENTION

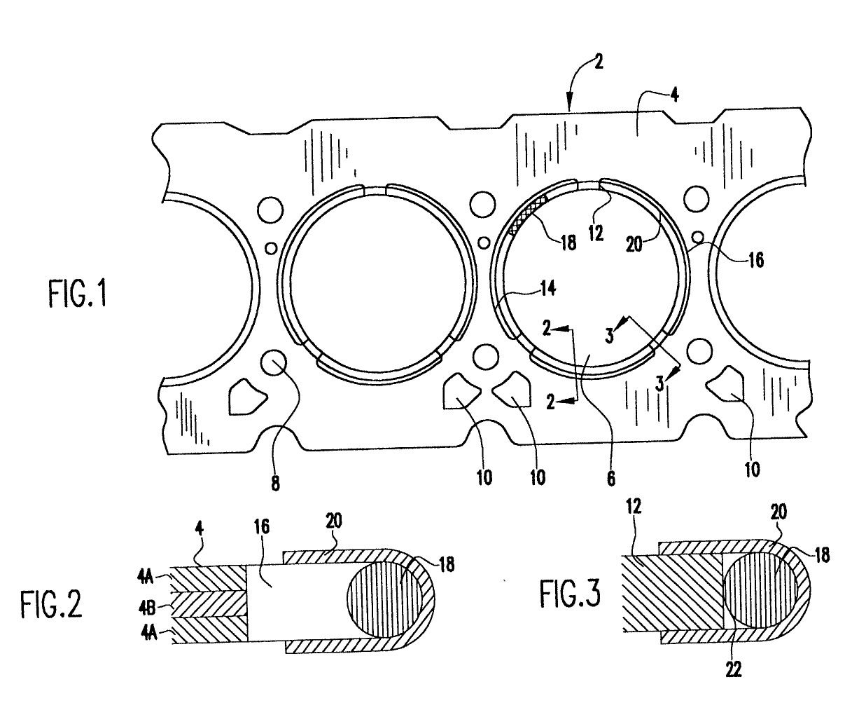

Referring to FIG. 1, a gasket assembly is generally depicted as reference numeral 2 and includes a gasket body 4 having openings 6 corresponding to respective combustion chambers of an internal combustion engine. The gasket body 4 further includes bolt holes 8, as well as lubricant and coolant apertures 10 formed therein. The gasket body 4 also includes tabs 12 extending outward toward the opening 6 from an inner circumference 14, and cut-out portions 16 positioned between the outward extending tabs 12. The extending tabs 12 are preferably integrally formed with the gasket body 4.

A fire ring 18 is provided about each respective opening 6 and is secured to the extending tabs 12 of the gasket body 4 by a wrap 20. More specifically, the wrap 20 wraps around the fire ring 12 and extends to and overlaps opposing sides of the extending tabs 12. In FIG. 1, the wrap 20 overlaps three extending tabs 12, but is it should be understood by those of skill in the art that more or less extending tabs 12 such as two to six or more extending tabs 12 may equally be used with the gasket assembly 2 of the present invention (depending on the particular dimensions of the fire ring 12 and the opening 6).

FIG. 2 is a sectional view along line 2-2 of the FIG. 1. FIG. 2 shows the fire ring 18 and the wrap 20 separated from the gasket body 4 by the cut-out portion 16. The wrap 20 is provided about the fire ring 18, and extends partly into the cut-out portion 16 but does not overlap the edges of the gasket body 4. The diameter of the fire ring 18 is approximately 1 mm and the cut-out portions 16 provide a spacing between the fire ring 18 and the gasket body 4 of approximately 3 mm to 5 mm, but these specific dimension may change depending on the size and application of the internal combustion engine used with the gasket assembly 2 of the present invention.

Still referring to FIG. 2, the gasket body 4 preferably comprises a laminate body structure having a metallic core layer 4b (preferably sheet metal) sandwiched between opposing fiber reinforced composite layers 4a. Layers 4a may alternatively be graphite or an elastomer material. The extending tabs 12 may also be formed of the same laminate structure. The fire ring 12 is preferably a low carbon steel or a stainless steel, and the wrap 20 is preferably a stainless steel or other material that is capable of protecting the gasket body 4 from high temperatures or combustion products such as, for example, corrosive oxides and the like.

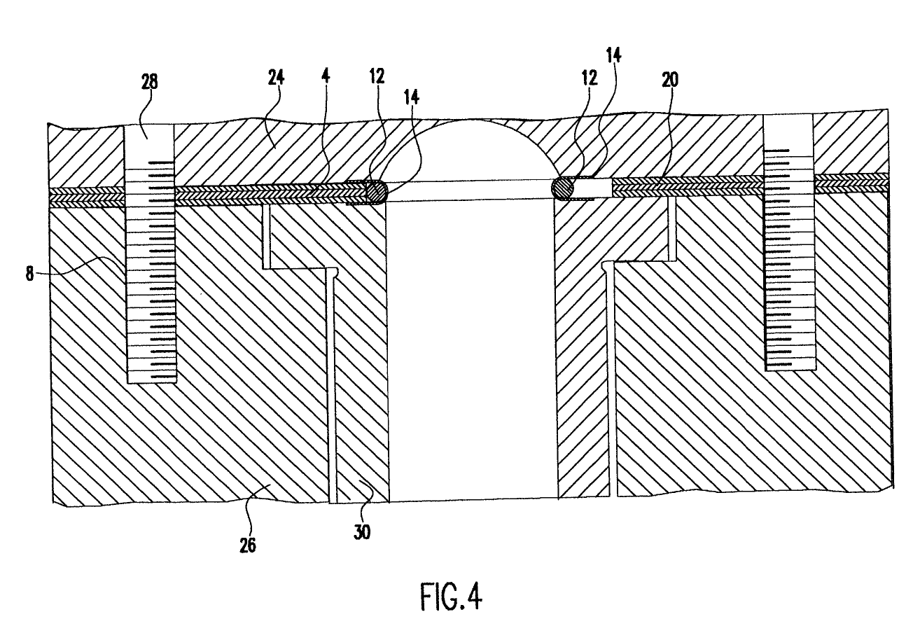

FIG. 3 is a section view along line 3-3 of FIG. 1. As seen in FIG. 3, the extending tab 12 extends to an attachment point 22, and the fire ring 18 is secured to the gasket body 4 via the wrap 20 extending over the extending tab 12. The wrap 18 extending over the extending tab 12, at this location, increases the thickness of the gasket assembly 4.

FIG. 4 shows a side sectional view of an internal combustion engine using the gasket assembly 2 of the present invention. More specifically, FIG. 4 shows a head 24 mounted to an engine block 26 by bolts 28 threaded in the bolt holes 8. The gasket assembly 2 is sandwiched between the head 24 and the engine block 26 so that the opening 6 is aligned with a combustion chamber 30. A liner 30 may be provided within the combustion chamber 30.

On a “first” (left) side of the combustion chamber 30, the extending tab 12 extends to the attachment point 22 on the fire ring 18 and the wrap 20 overlaps the opposing surfaces of the extending tab 12. On a “second” (right) side of the combustion chamber 30, the fire ring 18 and the wrap 20 are separated from the gasket body 4 by the cut-out portion 16. The thickness profile of the gasket assembly 2 at the cut-out portions 16 is less than a thickness profile of the gasket assembly 2 at the extending tab 12 when the head 24 is mounted to the engine block 26.

### INDUSTRIAL APPLICABILITY

In use, the gasket assembly 2 of the present invention is aligned on the engine block 26 so that each opening 6 corresponds with the respective combustion chambers 30. The head 24 is then bolted to the engine block 26 by the bolts 28 at a predetermined torque or number of turns. The bolting of the head 24 to the engine block 26 sandwiches the gasket assembly 2 between the head 24 and the engine block 26 and provides a load on the gasket assembly 2.

The cut-out portions 16 adjacent the combustion chamber 30 minimize the thickness profile of the gasket body 4 about the fire ring 18 and wrap 20 assembly by separating the wrap 20 from the gasket body 4. That is, a thickness profile of the gasket assembly 2 at the cut-out portions 16 is less than a thickness profile of the gasket assembly 2 at the extending tabs 12 when the head 24 is mounted to the engine block 26. This arrangement decreases the load about the combustion chamber 30 when the bolts 28 are tightened between the head 24 and the engine block 26. This decreased load about the combustion chamber 30 allows the load to be distributed (transmitted) more evenly (optimized) about the entire gasket body 4 over the engine block 26 (instead of being concentrated at the combustion chamber). This then provides a superior seal of the fluids within the head 24 and engine block 26 assembly.

Other aspects and features of the present invention can be obtained from a study of the drawings, the disclosure, and the appended claims.

1. A gasket assembly, comprising:
a gasket body;
an opening formed in the gasket body;
tabs extending from the gasket body toward the opening;
cut-out portions positioned between the tabs;
a fire ring provided about a circumference of the opening; and
a wrap securing the fire ring to the tabs.

2. The gasket assembly of claim 1, wherein the wrap wraps around the fire ring.

3. The gasket assembly of claim 2, wherein the wrap secures the fire ring to the gasket body.

4. The gasket assembly of claim 1, wherein the cut-out portions separate the fire ring and the wrap from the gasket body.

5. The gasket assembly of claim 1, wherein the wrap wraps around the fire ring and extends to and overlaps opposing sides of the tabs.

6. The gasket assembly of claim 5, wherein the tabs are three tabs and the wrap overlaps the three tabs.

7. The gasket assembly of claim 1, wherein the tabs range from two to six tabs.

8. The gasket assembly of claim 1, wherein the tabs contact the fire ring at attachment points.

9. The gasket assembly of claim 1, including bolt holes and lubricant and coolant apertures formed in the gasket body.

10. The gasket assembly of claim 1, wherein the tabs are integrally formed with the gasket body.

11. The gasket assembly of claim 1, wherein the wrap extends partly into the cut-out portions.

12. The gasket assembly of claim 11, wherein the wrap terminates prior to the gasket body.

13. The gasket assembly of claim 1, wherein the cut-out portions provide a spacing between the fire ring and the gasket body of approximately 3 mm to 5 mm.

14. The gasket assembly of claim 1, wherein the gasket body is a laminate body structure having a metallic core layer sandwiched between opposing fiber reinforced composite layers.

15. The gasket assembly of claim 14, wherein the wrap protects the gasket body from a combustion chamber environment.

16. A gasket assembly for an internal combustion engine, comprising:
a gasket body having an opening adapted to correspond with a combustion chamber of the internal combustion engine;
at least two tabs extending from the gasket body toward the opening;
at least two cut-out portions formed in the gasket body and separating each of the at least two tabs;
a fire ring positioned about a circumference of the opening; and
a wrap wrapping around the fire ring and extending to and overlapping opposing sides of each of the at least two tabs.

17. The gasket assembly of claim 16, wherein each of the at least two cut-out portions provide a spacing between the fire ring and the gasket body.

18. An internal combustion engine having a gasket assembly, comprising:
an engine block having a combustion chamber;
a head mounted on the engine block; and
a gasket assembly sandwiched between the engine block and the head, the gasket assembly including:
a gasket body;
an opening formed in the gasket body and corresponding to the combustion chamber of the engine block;
tabs extending from the gasket body towards the opening;
cut-out portions formed in the gasket body and separating the tabs;
a fire ring positioned about the opening; and
a wrap securing the fire ring to the tabs, the wrap being separated from the gasket body by the cut-out portions.

19. The internal combustion engine of claim 18, wherein a thickness profile of the gasket assembly at the cut-out portions is less than a thickness profile of the gasket assembly at the tabs when the head is mounted to the engine block.

20. The internal combustion engine of claim 18, wherein the tabs contact the fire ring at an attachment point.
